(19) United States
(12) Patent Application Publication
(10) Pub. No.: US 2026/0336795 A1
(43) Pub. Date: Oct. 29, 2026

(54) AIRCRAFT HIGH LIFT SYSTEM

(71) Applicant: AIRBUS OPERATIONS LIMITED, Bristol (GB)

(72) Inventor: Oliver FAMILY, Bristol (GB)

(21) Appl. No.: 19/463,819

(22) Filed: Jan. 29, 2026

(30) Foreign Application Priority Data
Feb. 6, 2025 (GB) 2501764.1

(51) Int. Cl. B64C 9/24; B64C 13/50; B64D 15/04; B64D 15/16; B64D 15/22

(52) U.S. Cl. CPC B64C 9/24; B64C 13/50; B64D 15/04; B64D 15/16; B64D 15/22

(57) ABSTRACT

An aircraft including a fixed wing with a folding wing portion and a high lift system having a high lift system controller and an actuation system configured to control and actuate the position of one or more wing leading edge high lift devices provided at the leading edges of both the fixed wing portion and at the folding wing portion between retracted and deployed positions. The high lift device for the folding wing portion is one or more slotted krueger device and wherein for at least one predetermined high lift device configuration, the one or more one slotted krueger device is actuated to its fully deployed position and the one or more high lift device provided at a leading edge portion of the fixed wing portion is not actuated to its fully deployed position. A method of operating the aircraft is also disclosed.

### CROSS RELATED APPLICATION

This application claims priority to United Kingdom Patent Application GB 2501764.1, filed Feb. 6, 2025, the entire contents of which is hereby incorporated by reference.

### BACKGROUND OF THE INVENTION

There is a trend towards increasingly large passenger aircraft, for which it is desirable to have correspondingly large wing spans to improve aerodynamic efficiency and performance of the aircraft during flight. Larger span aircraft still however need to operate within the dimensional limits set by existing aircraft airport gate categories. Each gate category has an associated maximum permissible wing span of aircraft when it is operated in and out of ground on taxiways and aircraft gates. A design challenge is to enable increasing the wing span of an aircraft for flight while keeping the wing span within the same maximum permissible gate limitations on ground. Aircraft designers are turning to aircraft designed with folding wing systems that allow the operator to fold the wing and reduce its span shortly after the aircraft has landed, and to unfold and increase the wing span for flight.

A further design challenge is to arrive at an optimal wing configuration that balances weight, complexity, operating reliability, manufacturability, and cost with the required level of aerodynamic performance and handling characteristics necessary for both low speed flight i.e., during the take-off, initial climb, final approach and landing, and high-speed flight i.e., during the extended climb, descent and normal cruise stages of flight of the aircraft. On the performance side, it is desirable that new aircraft achieve the same low speed performance as their predecessors, and this is achieved by providing a high lift system of movable leading edge devices that extend substantially across the span of the wing, including on the folding wing tip portion of the aircraft. This presents a challenge to the designer in terms of implementing a leading edge high lift device system across a folding wing joint and in a wing tip portion where there is limited space available for system installation.

Another important aircraft design consideration is the satisfactory operation of aircraft in known icing conditions, which for commercial aircraft necessitates the inclusion of aircraft anti-icing systems at the leading edges of the aircraft wings that prevents the build up of, or the removal of, any ice accretions from the wing leading edge while the aircraft is in flight. This includes the leading edge of wing high lift movables, which form the leading edge of the wing. The lack of available space in the leading edge of the wing (especially the further outboard you go on a wing) presents a challenge to aircraft designers to provide an anti-icing system that is sufficiently lightweight, low in complexity and high in reliability. This challenge is compounded in the case of aircraft with wing architectures having movable folding wingtips because the icing system installation also needs to transition across a folding wing joint at an outboard end of the wing. The joint presents a large discontinuity that leads to all folding wing portion systems installations such as high-lift, lighting, flight controls and anti-ice systems having to route through a significantly reduced area.

It is an object of the present invention to provide a high lift system and anti-icing system architecture for folding wing aircraft that meets these challenges whilst at the same time decreasing complexity, overall systems weight, installation time and maintenance requirements of the system, particularly at the folding wing portion of an aircraft.

### SUMMARY OF THE INVENTION

According to a first aspect of the invention, there is provided an aircraft comprising a wing further comprising a fixed wing portion and a folding wing portion that is rotatably attached at a hinge to an outboard end of the fixed wing portion. The aircraft further comprises a high lift system comprising a high lift system controller and an actuation system configured to control and actuate the position of one or more wing leading edge high lift devices provided at the leading edges of both the fixed wing portion and at the folding wing portion between retracted and deployed positions, wherein the position predetermined high lift device configurations commanded by the high lift system controller, wherein the one or more high lift device provided at the folding wing portion is one or more slotted krueger device actuatable between a fully retracted position and a fully deployed position and, wherein for at least one predetermined high lift device configuration, the one or more high lift device provided at the leading edge portion of the folding wing portion is actuated to its fully deployed position and the one or more high lift device provided at a leading edge portion of the fixed wing portion is not actuated to its fully deployed position.

One or more slotted krueger devices are provided outboard of the hinge line so that a separate anti-icing system is not required even when the aircraft is flown in known icing conditions. While ice accretions may form on the slotted Krueger device, the device itself will shield the leading edge of the fixed wing leading edge of the wing adjacent to and downstream (i.e. aftward) of the device to the extent that in known icing conditions there is acceptable levels of ice accretion on the wing fixed leading edge. The choice of a slotted type of krueger device is intentional, as the provision of a slot offsets any degradation in aerodynamic performance of the slotted krueger device due to any ice accretions attached to it. These characteristics of the arrangement enable a folding wing architecture to be considered whereby one or more high lift devices in the form of one or more slotted Krueger device is provided outboard of the folding hinge joint not only to provide high lift performance when needed but also to negate the need for a separate anti-icing system outboard of the folding wing joint as mentioned. This is not only advantageous in terms of weight and complexity, but also reduces the amount of system installation space required overall across the hinge line. This may also allow further additional systems to be implemented adjacent to the folding wing hinge or further outboard in the folding wing portion.

The at least one predetermined high lift system configuration may be designed or configured such that the one or more high lift device provided at the leading edge of the fixed wing portion is actuated to a fully retracted position when the one or more slotted Krueger device is held in a fully deployed position on the folding wing portion. Such a configuration may be advantageous in manoeuvres where extending the aircraft flight endurance as much as possible is required while it is also encountering icing conditions.

Anti-icing systems are often designed to provide sufficient amounts of heat energy to be transferred to the leading edge structure when the aircraft is flying in known icing conditions at such higher airspeeds. Preventing ice accretion along the wing leading edge is desired as is also enabling a maximum aircraft flight endurance, which necessitates reducing drag as much as possible. For the present invention, the optimum performance may be achieved by fully deploying one or more slotted krueger device on the folding wing portion to prevent ice accretion to the leading edge of the folding wing portion, whilst at the same time having the one or more high lift devices in the fixed wing portion fully retracted to reduce drag.

Such a manoeuvre may preferably correspond to the aircraft flying a holding manoeuvre in known icing conditions. Further still, the at least one predetermined high lift device configuration may preferably correspond to an aircraft flight holding speed between 170 and 270 knots indicated airspeed which is an optimal speed range for commercial passenger aircraft depending on the weight and altitude of the aircraft at the time the aircraft is in flight and performing a holding manoeuvre.

Preferably, the one or more slotted krueger device may further comprise a deployable bull-nose to increase the aerodynamic performance of the slotted krueger device and in addition to facilitate the breakup of any ice accretions adhered to the surface of the one or more slotted krueger device during its retraction from the fully deployed position, or alternatively during deployment.

Preferably, the one or more slotted krueger device may further comprise a flexible panel portion configured to change in curvature between the fully retracted and fully deployed positions in order to increase the aerodynamic performance of the krueger device and wing, and in addition, to facilitate the breakup of any ice accretions adhered to the surface of the flexible panel of the one or more slotted krueger device during its retraction from the fully deployed position, or alternatively during deployment.

Preferably, the one or more slotted krueger device may further comprise an outer surface portion comprising a hydrophobic surface texture or a nanocomposite coating configured to inhibit ice accretion to the surface. Such a textured surface or coating may further prevent the accretion of ice on the one or more slotted krueger device when it is deployed or retracted, thereby enhancing its aerodynamic performance.

Preferably, the aircraft may further comprise an actuation system further comprising one or more electrically powered actuators positioned within the folding wing portion and configured to drive the one or more slotted krueger device between the fully retracted and fully deployed positions. The use of electrically powered actuators may further reduce the space allocation required for the system installation across the hinge joint, thereby decreasing the complexity of the system design or reducing the overall system weight.

Preferably, the aircraft may further comprise a fixed wing anti-icing system configurable between an active mode wherein heat energy is transferred to the leading edge of the fixed wing portion, and a dormant mode wherein heat energy is not transferred, and wherein the high lift system is further configured to actuate the one or more slotted krueger device to the at least one predetermined high lift device configuration when the anti-icing system is configured to the active mode. Such a design enables the anti-icing and high lift system function to be synchronised such that pilot workload is reduced, leading to a more efficient and less demanding system design from the perspective of the operator.

Preferably, the anti-icing system may further comprise an aircraft speed sensor configured to sense the airspeed of the aircraft or an ice condition sensor configured to sense the conditions necessary for the formation of wing ice and wherein the dormant mode is selected automatically when aircraft speed is above a predetermined airspeed threshold value or when the necessary conditions for ice accretion are determined not to be present. Such a design enables the anti-icing and high lift system function to be synchronised such that pilot workload is reduced, leading to a more efficient and less demanding system design from the perspective of the operator.

Further still, the anti-icing system may further comprise an aircraft speed sensor configured to sense the airspeed of the aircraft or an ice condition sensor configured to sense the conditions necessary for the formation of wing ice and wherein the active mode is selected automatically when aircraft speed is below a predetermined airspeed range threshold value or the necessary conditions for ice accretion are determined to be present.

According to a second aspect of the present invention, there is provided a method of operating an aircraft according to the first aspect of the present invention, the method comprising the steps of:
a. providing an aircraft with a high lift system comprising one or more wing leading edge high lift devices positioned corresponding to a predetermined high lift device configuration;
b. commanding the high lift system to actuate to the high lift devices corresponding to the at least one predetermined high lift device configuration wherein the one or more high lift device provided at a leading edge portion of the folding wing portion is to be positioned at a fully deployed position and the one or more high lift device provided at a leading edge portion of the fixed wing portion is not to be positioned at a fully deployed position.
c. actuating the one or more high lift devices to their commanded positions.

Preferably, the position of the one or more high lift devices provided at the leading edge portion of the fixed wing portion for the at least one predetermined high lift device configuration, is the fully retracted position, which is advantageous for the reasons previously discussed. Furthermore, the predetermined high lift system configuration may be a high speed flight configuration whereby the one or more high lift devices corresponding to this configuration are all positioned in their fully retracted positions. Such a high speed configuration may correspond advantageously to the speed range or holding manoeuvre as previously mentioned. The method may alternatively comprise operating an aircraft with a predetermined high lift system configuration corresponding to a low speed flight configuration i.e. a configuration for flying the aircraft below 170kts KIAS, which is typical for the takeoff or landing phases of an aircraft flight.

The aircraft is preferably a commercial passenger aircraft. The passenger aircraft preferably comprises a passenger cabin comprising a plurality of rows and columns of seat units for accommodating a multiplicity of passengers. The aircraft may have a capacity of at least 20, more preferably at least 50 passengers, and more preferably more than 50 passengers. The aircraft may preferably have a maximum takeoff weight greater than 60000KG. The aircraft is preferably a powered aircraft. The aircraft preferably comprises an engine for propelling the aircraft. The aircraft may comprise wing-mounted, and preferably underwing, engines.

It will be appreciated that any features described with reference to one aspect of the invention are equally applicable to any other aspect of the invention, and vice versa.

### DESCRIPTION OF THE DRAWINGS

Embodiments of the present invention will now be described by way of example only with reference to the accompanying schematic drawings.

FIG. 1A shows a plan projection view of an aircraft with a wing with high lift devices configured in a high speed ‘clean’ cruise flight configuration according to an embodiment of the invention.

FIG. 1B shows section view through line A-A of FIG. 1A looking in an outboard direction and showing details of the wing leading edge and high lift system of the aircraft of FIG. 1A.

FIG. 2A shows a partial plan projection view of the aircraft of FIGS. 1A and 3A but with a wing with high lift devices in a high speed hold flight configuration according to an embodiment of the invention.

FIG. 2B shows section view through line A-A of FIG. 2A looking in an outboard direction and showing details of the wing leading edge and high lift system of the aircraft of FIG. 2A.

FIG. 3A shows a partial plan projection view of the aircraft of FIGS. 1A and 2A but with a wing with high lift devices in a landing or takeoff flight configuration according to an embodiment of the invention.

FIG. 3B shows section view through line A-A of FIG. 3A looking in an outboard direction and showing details of the wing leading edge and high lift system of the aircraft of FIG. 3A.

### DETAILED DESCRIPTION

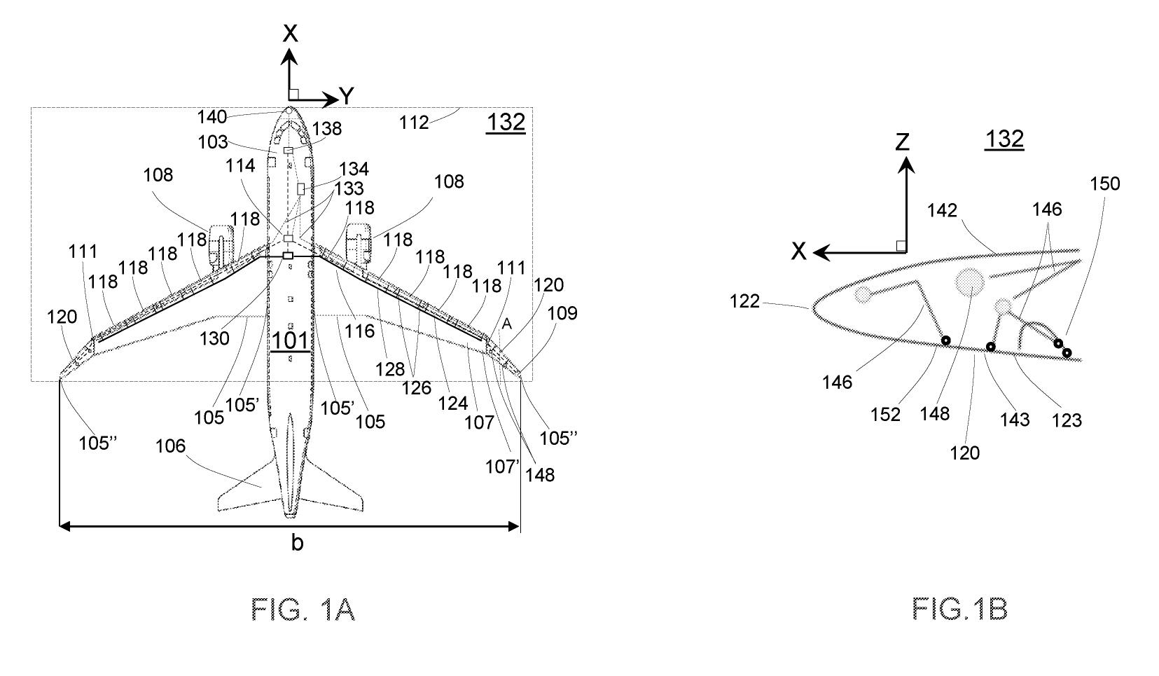

Referring to FIG. 1A, an aircraft 101 according to an embodiment of the invention is shown. The aircraft 101 comprises a central fuselage 103, two main wings 105, a tail 106, and a pair of wing mounted jet engines 108. The aircraft 101 has a set of orthogonal aircraft axes X, Y, and Z. The longitudinal aircraft axis (X) has its origin at the centre of gravity of the aircraft 101 and extends lengthwise through the fuselage 103. The lateral aircraft axis (Y) (or spanwise axis) shares the same origin, and extends laterally, orthogonal to the longitudinal axis (X) in the direction indicated. Finally, the vertical or normal axis (Z) again shares the same origin and extends vertically, orthogonal to both the longitudinal axis (X) and the lateral axis (Y) in the direction indicated. Each wing 105 extends outwardly from the fuselage 103 from respective wing roots 105’.

Each wing 105 further comprises a fixed wing portion 107 extending from the root 105’ to an outboard end of the fixed wing portion 107’. At the fixed wing portion end 107’, each wing 105 also comprises a rotatable wing tip portion 109, in the form of a planar wing tip extension, which further comprises a wing tip 105” of the wing 105. The folding wing tip portion 109 is rotatably mounted about a hinge axis at a hinge 111 to the outboard end 107’ of the fixed wing portion 107.

As shown, the aircraft 101 has an overall maximum wing spanwise length b (wing span) equal to the distance measured in the XY plane in the Y direction between wing tips 105” when for both wings the folding wing portion 109 is rotated to an unfolded position such that the upper surfaces 142 and lower surfaces 143 of the folding wing portion 109 and fixed wing portion 107 are continuations. The aircraft 101 has a shorter wingspan b when the folding wing portion 109 of each wing 105 is rotated to an opposite folded upward position (not shown).

With further reference to FIGS. 1A and 1B, each wing 105 of the aircraft 101 comprises a high lift system 112. The high lift system 112 comprises a high lift device controller 114, a high lift device actuation system 116, and a plurality of deployable wing leading edge high lift devices 118, 120 located forward (i.e. positive X direction) relative to the fixed and folding wing portions 107, 109, as shown.

With further reference to all figures provided, a number of predetermined high lift device configurations 132, 232, 332 are provided by the high lift system 112 such that for each configuration 132, 232, 332, corresponding positions of each of the high lift devices 118, 120 are obtained relative to the fixed and folding wing portions 107, 109. For the predetermined high lift device configuration 132 of FIGS. 1A and 1B, the high lift devices 118, 120 are all in a fully retracted position (as shown). Such a configuration is typically commanded by the pilot or flight management system 138 to the high lift device controller 114 when a high speed climb/descent phase or cruise flight phases of the aircraft 101 is expected.

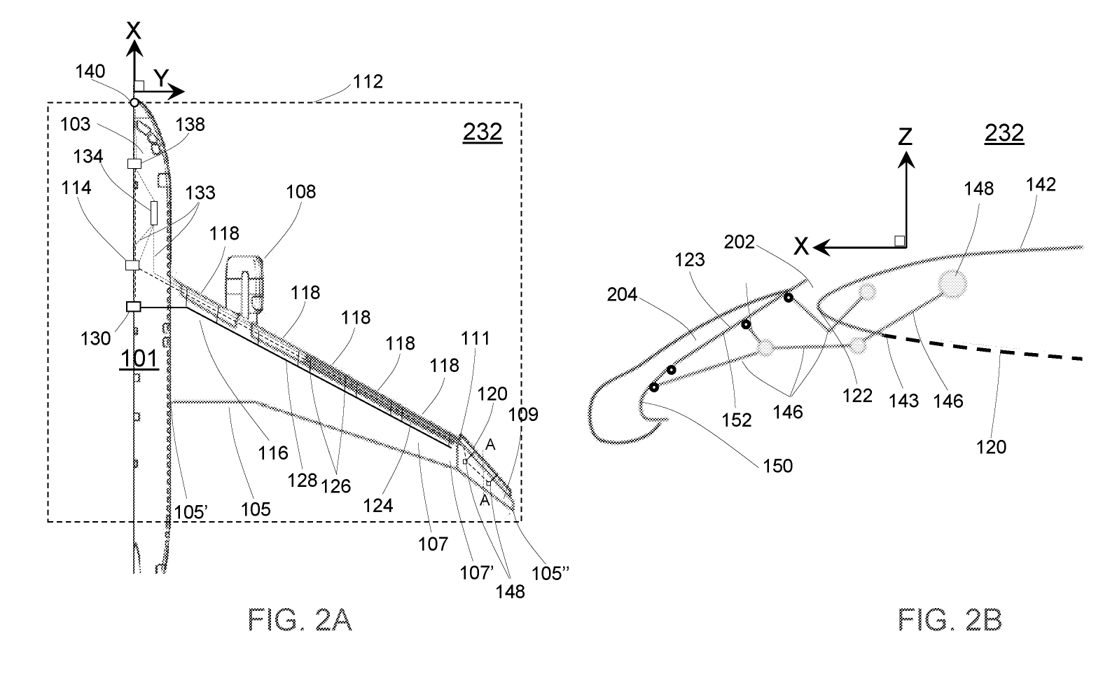

For the predetermined high lift device configuration 232 of FIGS. 2A and 2B, the high lift devices 118 for the fixed wing portion 107 are all in a fully retracted position and the high lift devices 120 for the folding wing portion 109 are all in a fully extended position (as shown). Such a configuration is commanded by the pilot or flight management system 138 to the high lift device controller 114 when a holding phase of the aircraft 101 is expected and when flying in known icing conditions.

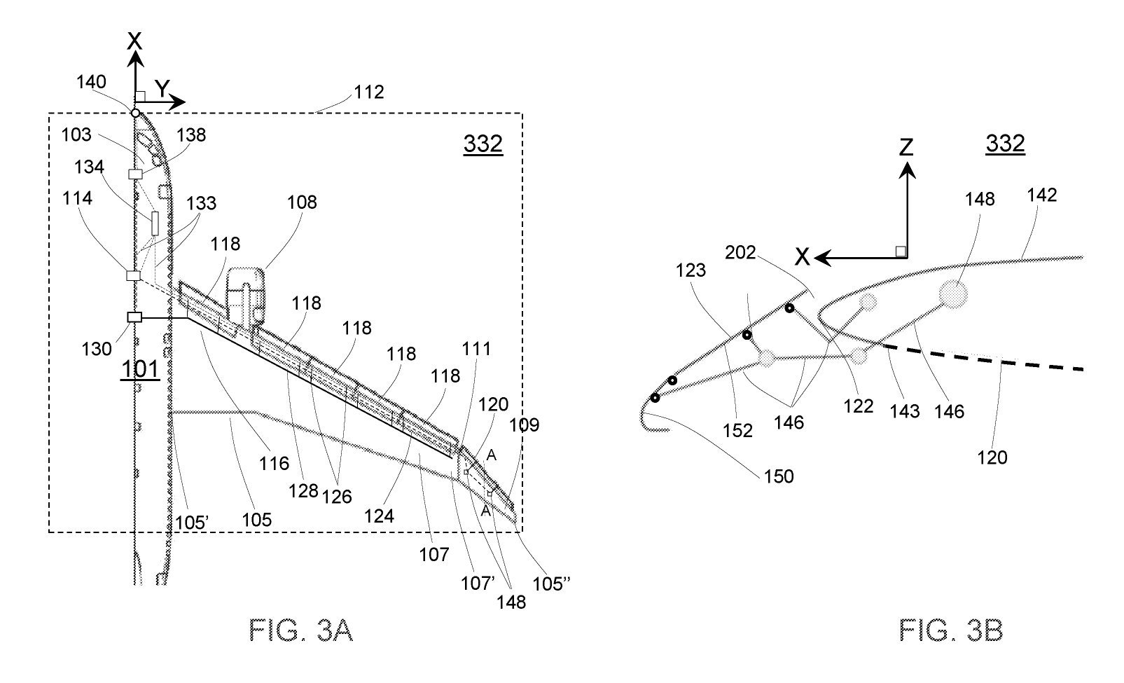

For the predetermined high lift device configuration 332 of FIGS. 3A and 3B, the high lift devices 118 for the fixed wing portion 107 are all in an extended position and the high lift devices 120 for the folding wing portion 109 are also all in a fully extended position (as shown). Such a configuration is commanded by the pilot or flight management system 138 to the high lift device controller 114 when a low speed landing or takeoff phase of the aircraft 101 is expected.

For the fixed wing portion 107 of the wing 105, the high lift device actuation system 116 is configured to actuate ten high lift devices (five per wing) 118, which are in the form of slat devices 118 in the present example, in response to a configuration command received from the high lift device controller 114 having received its configuration command from the pilot or flight management system 138. The layout and function of the system 116 is identical for each wing 105, therefore detail and item numbers are omitted for the left hand wing 105 in FIGS. 2A and 3A. Each slat device 118 forms the leading edge 122, upper surface 142 and lower surface 143 of the wing 105 when in the fully retracted position i.e when positioned in the predetermined high lift device configuration 132, as shown.

Each slat 118 is movably mounted to a fixed leading edge portion 124 of the fixed wing 107 by a slat track mechanism consisting of a pair of slat tracks 126. The actuation system 116 for each slat 118 comprises the pair of driven slat tracks 126 that are each connected via gearbox (not shown) at each track position to a centralised transmission shaft 128 that is routed within the fixed leading edge 124 of each wing 105 forward (ie in positive X direction) of a front spar (not shown). The position of each slat 118 is adjustable in response to directional torque provided by a centralised hydraulic motor 130 so that, in effect, driving the transmission shaft 128 in either rotational direction by the motor 130 changes the position of the slats 118 relative to the fixed wing portion 107.

An aircraft wing anti-icing system 133 is provided comprising an anti icing system controller 134 which is configured to communicate with, and control, a set of bleed air take off valves (not shown) located at each engine 108. These valves fluidly connect with pneumatic supply lines that are integrated into the leading edge 124 of each fixed wing portion 107 and are fluidly connected with one or more piccolo tubes (not shown) that are enclosed within each slat 118. When the engine bleed valves are commanded to open by the controller 134, high pressure and high temperature bleed air from the engines 108 is fed into the piccolo tubes, which transfers heat energy to the surfaces of the slats 118 in order to provide the anti-icing function. This is provided when the anti-icing system controller 134 is placed into an active mode by a pilot or a flight control system 138. The supply of bleed air (and hence transfer to the slats 118) is cut off by the valves when the anti-icing system controller 134 is placed into a dormant mode by the pilot or the flight control system 138.

For the folding wing portion 109 of each wing 105, the high lift device actuation system 116 is configured to actuate 2 high lift devices (1 per wing) 120, which are in the form of slotted krueger devices 120. Alternatively more than one slotted krueger device 120 may be provided per folding wing portion 109.

With reference to FIG. 1B, it is seen that, unlike the slats 118, each slotted krueger device 120 does not encapsulate the fixed leading edge 122 of the wing 105 when in the fully retracted position corresponding to the predetermined configuration 132 shown. Instead, an external surface 123 of slotted krueger device 120 in the fully retracted position forms a continuous portion of the lower surface 143 of the leading edge the folding wing portion 109 that extends aftwards (i.e. in the negative X direction) and adjacent to the leading edge 122. Each slotted krueger device 120 is movably supported at two spanwise locations to a fixed leading edge portion 124 of the folding wing portion 109 by a series of driven 4 bar kinematic linkages 146. An exemplary kinematic and slotted krueger device 120 at one spanwise station is shown in FIG. 1B, as is also the case for 2B and 3B but for different configurations. At each spanwise location, the linkages 146 are directly driven by a corresponding electrical geared rotary actuator 148 between a fully retracted position (as shown) and a fully extended position as shown in the further one or more predetermined configurations of 232 and 332, shown in FIGS. 2B and 3B, respectively. Further intermediate positions of the slotted krueger device 120 between the fully retracted and extended positions may also be provided.

The required positions of the slotted krueger device 120 for each predetermined configuration 132, 232, 332 are obtained for the folding wing portion 109 by the operation of the high lift system controller 114 also controlling the duration and direction in which electric geared rotary actuator 148 operates. Exactly which corresponding position each slotted krueger device 120 is driven to is determined by the configuration commanded by the high lift system controller 114 which controls the operation of the electric geared rotary actuators 148 and also the centralised hydraulic motors 130 to position the high lift devices 118, 120 in a synchronised manner to ensure that predetermined configurations 132, 232, 332 are achieved when commanded by the pilot or flight management system 138.

The design of the kinematic linkages 146 is chosen such that when the slotted krueger device 120 is extended to the fully deployed position 232, 332 (see FIG. 2B and 3B), the slotted krueger device 120 is placed adjacent to, and forward of, the leading edge of the folding wing 122 and a slot 202 is provided between the slotted krueger device 120 and the fixed leading edge 122 of the folding wing portion 109, as shown (hence the term ‘slotted’).

Such a design has two key effects in the context of the present invention. Firstly, the device in this position shields the fixed leading edge 122 of the folding wing portion 109 such that when the aircraft 101 is flying in known icing conditions, ice accretions 204 will form on the surface 123 of the slotted krueger device 120 rather than on the fixed leading edge portion 122 of the folding wing portion 109. Secondly, the degradation in performance of the slotted krueger device 120 due to the presence of any resulting ice accretions 204 will be counteracted by the aerodynamic performance provided by the presence of the slot 202, which allows high pressure airflow from the lower surface 143 of the wing 105 to be diverted through to the upper surface 142 of the folding wing portion 109, thereby delaying the turbulent transition of airflow along the upper surface 142.

Such a design enables the flight configuration shown in FIG. 2A and 2B, corresponding to the aircraft 101 being configured for holding flight in known icing conditions, where ice accretions 204 are shown attached to the slotted krueger device 120 rather than being attached to the leading edge 122 of the folding wing portion 109. Such a high lift system 112 architecture for the wing 105 negates the need for a separate anti-icing system for the folding wing portion 109, which is advantageous in that the requirements for systems installation of the high lift device actuation system 116 across the hinge 111 are more relaxed. In the present example, only cabling across the joint hinge 111 is needed to provide power, control and monitoring of the electrical actuators. This ultimately leads to a less complex, more compact and a lighter design in comparison to an alternative where the actuation system 116 and pneumatic based anti-icing system 134 used for the fixed wing portion 107 are extended across the hinge 111 to the folding wing portion 109.

The anti icing system controller 134 of the aircraft wing anti icing system 133 is further configured to communicate with the high lift system controller 114, wherein the high lift system controller 114 is configured to actuate the slotted krueger devices 120 to the fully extended position shown in FIG. 2A and 2B corresponding to the predetermined high lift device configuration 232, when the anti-icing system 133 is configured to the active mode.

The flight management system 138 may further be configured to communicate with a combined aircraft speed and ice condition sensor 140. The sensor 140 is configured to sense the airspeed of the aircraft 101 and sense the temperature and humidity conditions necessary for the formation of wing ice. It should be appreciated that a multitude of separate sensors may be provided to sense the same conditions, and that these sensors may serve multiple systems of the aircraft 101 or be part of the anti-icing system 133.

The active or dormant mode of the anti-icing system 133 is selected automatically by the flight control system 138 depending on the aircraft speed and whether the speed is below a predetermined airspeed threshold value of 270 KIAS, and whether or not the necessary conditions for ice accretion are determined to be present. The threshold value may be optimised for the altitude and weight of the aircraft 101. The flight management system 138 may use altitude and weight values of the aircraft 101 available to the system 138 in combination with a lookup table of predetermined optimal holding speed vs aircraft altitude and weight and configuration values in order to determine the predetermined airspeed threshold value.

The anti icing system 133 will communicate a change to an active mode to the high lift system controller 114, which in turn will command the actuation of the slotted krueger devices 120 to the fully extended position as shown in FIG. 2A and 2B, when the airspeed is below 270 KIAS and whether or not the temperature and humidity conditions necessary for the formation of wing ice are sensed.

The anti icing system 133 will communicate a change to a dormant mode to the high lift system controller 114, which in turn will command the actuation of the slotted krueger devices 120 to the fully retracted position as shown in FIG. 1A and 1B, when the airspeed is above 270 KIA.

The slotted krueger device 120 kinematic also includes a retractable nose fairing (‘bullnose’) 150 which increases the fully deployed device size. This reduces the negative aerodynamic impact of the slotted krueger device 120 as it transitions between the fully retracted and fully extended positions, while also encouraging ice accretions to fracture and hence facilitate their detachment from the slotted krueger device 120 when it is retracted from the fully extended position or when it is deployed.

The device also comprises a flexible panel portion 152 that is configured to deform and change in camber of the device 120 as the device moves between fully retracted and deployed position(s), as shown. The deformation of the flexible panel 152 also advantageously encourages ice accretions 204 to detach or fracture which further facilitates their detachment from the slotted krueger device 120 when it is retracted from the fully extended position, or when it is deployed. Surface textures or specific surface coatings may also be applied to the surface of the slotted krueger device to reduce attachment of ice accretions to the krueger device.

With reference to all of the figures provided, a method of operating an aircraft 101 is shown. The aircraft 101 with the high lift system 112 is provided with the high lift devices 118, 120 positioned corresponding to a predetermined high lift device configuration 132 in FIG. 1A and 1B or 332 corresponding to FIG. 3A and 3B. In response to a command received from the flight control system 138, the high lift system controller 114 of the high lift system 112 commands the central hydraulic motor 130 or electric geared rotary actuators 148 of the actuation system 116 to operate and to actuate to the slats 118 or slotted krueger devices 120 corresponding to the at least one predetermined high lift device configuration 232, wherein the one or more slotted krueger devices 120 provided at a leading edge portion of the folding wing portion 109 are to be positioned at a fully deployed position and the one or more slats 118 are not to be positioned at a fully deployed position. Thereafter the actuation system 116 places the high lift devices 118 and 120 in positions corresponding to the commanded configuration 232. It should be appreciated that one or more of the slats 118 may not be fully retracted according to the configuration 232, and instead be held at a position between their fully deployed and fully retracted positions more suitable for sustained flight at a lower speed holding flight configuration in known icing conditions. Alternatively all slats 118 may be actuated to the fully retracted position more suitable for sustained flight in a higher speed holding flight configuration in known icing conditions.

Whilst the present invention has been described and illustrated with reference to particular embodiments, it will be appreciated by those of ordinary skill in the art that the invention lends itself to many different variations not specifically illustrated herein. By way of example only, in other embodiments (not shown) the one or slotted krueger device 120 may comprise a hydraulic actuator for actuation purposes.

The slats 118 on the fixed wing portion 107 may be any other type or number of high lift devices, including krueger devices, droop nose devices etc. The activation of the anti-icing system 133 may be manually commanded by the pilot of the aircraft. The aircraft 101 may be any kind of fixed wing aircraft certified to fly in known icing conditions. The anti-icing system for the fixed wing portion 107 may be heat transfer based (as described), or instead be deformation based (e.g. de-icing boots) or any other suitable alternative.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. An aircraft, comprising:
1a. a wing further comprising a fixed wing portion and a folding wing portion that is rotatably attached at a hinge to an outboard end of the fixed wing portion;
1b. a high lift system comprising a high lift system controller and an actuation system configured to control and actuate the position of one or more wing leading edge high lift devices provided at the leading edges of both the fixed wing portion and at the folding wing portion between retracted and deployed positions, wherein the position predetermined high lift device configurations commanded by the high lift system controller;
1c. wherein the one or more high lift device provided at the folding wing portion is one or more slotted Krueger device actuatable between a fully retracted position and a fully deployed position; and,
1d. wherein for at least one predetermined high lift device configuration, the one or more high lift device provided at the leading edge portion of the folding wing portion is actuated to its fully deployed position and the one or more high lift device provided at a leading edge portion of the fixed wing portion is not actuated to its fully deployed position.

2. The aircraft of claim 1, wherein for the at least one predetermined high lift device configuration, wherein the one or more high lift device provided at a leading edge portion of the fixed wing portion is actuated to its fully retracted position.

3. The aircraft of claim 1, wherein the at least one predetermined high lift device configuration corresponds to the aircraft performing a hold manoeuvre when the aircraft is in flight.

4. The aircraft of claim 1, wherein the at least one predetermined high lift device configuration corresponds to an aircraft flight speed between 170 and 265 knots indicated airspeed.

5. The aircraft of claim 1, wherein the one or more slotted krueger device comprises a deployable bull-nose.

6. The aircraft of claim 1, wherein the one or more slotted krueger device comprises a flexible panel.

7. The aircraft of claim 1, wherein an outer surface portion of the one or more slotted krueger device comprises a hydrophobic surface texture configured to inhibit ice accretion to the surface.

8. The aircraft of claim 1, wherein an outer surface portion of the one or more slotted krueger device comprises a nanocomposite coating configured to inhibit ice accretion to the surface.

9. The aircraft of claim 1, wherein the actuation system comprises one or more electrically powered actuator positioned within the folding wing portion and configured to drive the one or more slotted krueger device between the fully retracted and fully deployed positions.

10. The aircraft of claim 1, further comprising a fixed wing anti-icing system configurable between an active mode wherein heat energy is transferred to the leading edge of the fixed wing portion, and a dormant mode wherein heat energy is not transferred, and wherein the high lift system is further configured to actuate the one or more slotted krueger device to the at least one predetermined high lift device configuration when the anti-icing system is configured to the active mode.

11. The aircraft of claim 10, wherein the anti-icing system further comprises an aircraft speed sensor configured to sense the airspeed of the aircraft or an ice condition sensor configured to sense the conditions necessary for the formation of wing ice and wherein the dormant mode is selected when aircraft speed is above a predetermined airspeed threshold value or the necessary conditions for ice accretion are determined not to be present.

12. A method of operating an aircraft according to claim 1, comprising the steps of:
12a. providing an aircraft with a high lift system comprising one or more wing leading edge high lift devices positioned corresponding to a predetermined high lift device configuration;
12b. commanding the high lift system to actuate to the high lift devices corresponding to the at least one predetermined high lift device configuration wherein the one or more high lift devices provided at a leading edge portion of the folding wing portion is to be positioned at a fully deployed position and the one or more high lift devices provided at a leading edge portion of the fixed wing portion is not to be positioned at a fully deployed position.
12c. actuating the one or more high lift devices to their commanded positions.

13. The method of operating an aircraft according to claim 12, wherein
the position of the one or more high lift devices provided at the leading edge portion of the fixed wing portion for the at least one predetermined high lift device configuration, is the fully retracted position.

14. The method of operating an aircraft according to claim 12, wherein the predetermined high lift system configuration is a high speed flight configuration whereby the one or more high lift devices corresponding to this configuration are all positioned in their fully retracted positions.

15. The method of operating an aircraft according to claim 12, wherein the predetermined high lift system configuration is a low speed flight configuration.
